(19) United States
(12) Patent Application Publication
(10) Pub. No.: US 2021/0221555 A1
(43) Pub. Date: Jul. 22, 2021

(54) EASY TEAR CORNET PACKAGE

(71) Applicant: MONDI KALE NOBEL AMBALAJ SANAYI VE TICARET ANONIM SIRKETI, Kirklareli (TR)

(72) Inventors: Umit SAHIN, Kirklareli (TR); Osman KADIROGLU, Kirklareli (TR)

(21) Appl. No.: 16/099,930

(22) PCT Filed: Oct. 29, 2018
(86) PCT No.: PCT/TR2018/050634

§ 371 Date: Nov. 8, 2018

(30) Foreign Application Priority Data
Sep. 11, 2018 (TR) 2018/13006

(51) Int. Cl. B65D 3/26; B65D 85/78; A23G 9/50; B65D 3/06

(52) U.S. Cl. CPC B65D 3/262; B65D 85/78; A23G 9/503; B65D 2517/0013; A23G 2220/12; B65D 2517/0008; B65D 3/06

(57) ABSTRACT

The invention relates to an easy-to-tear cornet package (A) used for packaging the cone-shaped cornet-type ice creams. The invention is characterized in that the cornet package (A) is easily separated from the cornet ice cream by correct and wide-area tearing of the upper tear line (5) and lower tear line (6), both of which have the concave form, after pulling the holding protrusion (4) situated between the upper curve (2) and lower curve (3) which are inwardly formed on the outer edge line (1) forming the opening portion.

### TECHNICAL FIELD

The invention relates to an easy-to-tear cornet package which is used for packaging the cone-shaped cornet-type ice creams.

### STATE OF THE ART

Cornet ice creams are one of the most popular ice creams consumed frequently. This type of ice cream has a cone-shaped cornet filled with ice cream with ingredients such as chocolate, sauce, fruit, nuts.

Cornet ice creams are offered for sale by using sheath-shaped packages covering the cone section and circular caps closed on said corn. The cornet ice cream is packed and made ready for sale after the cornet cones are placed in a sheath-shaped package, the cornet is covered with a cap, and the excess portion at the upper edge of the sheath is fixed on the cap. Cornet ice cream is consumed after tearing the cornet package which is wrapped on it. In this regard, it is important to have a package structure which protects the cornet ice cream in good conditions and which is suitable to be easily opened without disturbing the consumer and without damaging the form of ice cream.

In the prior art, said cornet ice cream packages have been the subject of some improvements for the reasons mentioned above.

One example of this improvement in the literature is the patent document DE10056811A1 The said invention relates to a “>” shaped ice cream package having lased tear-off lines and a tear protrusion having an outward curve between said tear-off lines. In the invention, it has been tried to ensure that the cornet ice cream package is torn from the tear-off lines and separated from the ice cream by pulling said tear protrusion. However, the tear protrusion breaks off during the pulling process and is unable to perform its function due to the fact that the tear protrusion has an outward curvature.

The length of the tear-off line extending to the upper edge, which is one of the tear-off lines of the invention, is short. This causes the tear-off process not to cover a wide area. In addition, the “>” shaped tear-off lines prevent the package from conveniently tearing along the line in respect to the tear-off line. This causes the package to not be separated from the ice cream as a whole and to be torn into pieces on the cone in a way that the consumer will struggle.

In the ice cream package shown in the present invention, the edge line of the tear protrusion is produced by being cut outwardly on a vertical plane. Therefore, the cost of the production of the package in question is high due to the large amount of waste raw material.

Another example of the improvements in the state of art is the patent document EP022683481. This invention relates to a cornet-shaped ice cream package which includes the horizontal tear lines advancing in the flat form, tear-off edge aligned with the entire edge line, and the indent-shaped notches which are formed at the start and end point of the tear lines on both sides of said tear-off edge to reduce the initial force to be applied to the tear lines by separating the tear-off edge from the entire edge line. In the invention, it has been tried to ensure that the cornet ice cream package is torn from the tear lines by pulling said tear-off edge and separated from the ice cream. However, since the horizontal tear lines have a straight line, tearing on a straight line cannot be smoothly performed. In addition, it is not possible to easily see the notch-separated tear-off edge through said edge line and grab it by fingers.

Consequently, the existence of the above problems and the insufficiency of existing solutions necessitated an improvement in the relevant technical field.

### Objectives of the Invention

Starting from the state of the art, the main object of the invention is to obtain an easy-to-tear cornet package by which the advantages are provided by eliminating disadvantages in the prior art.

A further main object of the invention is that the cornet package has an outer edge line that forms the opening portion with the upper curve and the lower curve which are inwardly formed and holding protrusion formed between the curves of said outer edge line.

A further main object of the invention is that said holding protrusion is at a height higher than the half-length of the cornet package length.

Another main object of the invention is to provide that the holding protrusion is easily seen and easily gripped by means of said curves of the outer edge line forming the opening portion of the cornet package and the cornet package is easily torn.

A further main object of the invention is that the cornet package has lower and upper tear lines having the concave form and the shape of “−” which are providing correct and wide-area tearing.

Another main object of the invention is that said upper tear line extending to the upper edge of the cornet package has a long length.

Another main object of the invention is to reduce the costs due to reducing the waste raw material by producing the outer edge line forming the opening portion of the cornet package by the inwardly cutting in a vertical plane.

### SHORT DESCRIPTION OF THE DRAWINGS

FIG. 1 is an exploded view of the cornet package of the invention.

FIG. 2 is a closed view of the cornet package of the invention,

FIG. 3 is a detail view of the outer edge line of the production waste of the cornet package of the invention.

### REFERENCES

1 Outer edge line
2 Upper curve
3 Lower curve
4 Holding protrusion
5 Upper tear line
6 Lower tear line
7 Inner edge line
A Cornet package
H Waste raw material

### DETAILED DESCRIPTION OF THE INVENTION

In this detailed description, the easy tear cornet package (A) according to the invention is described only as an example far a better understanding of the subject and without any limiting effect.

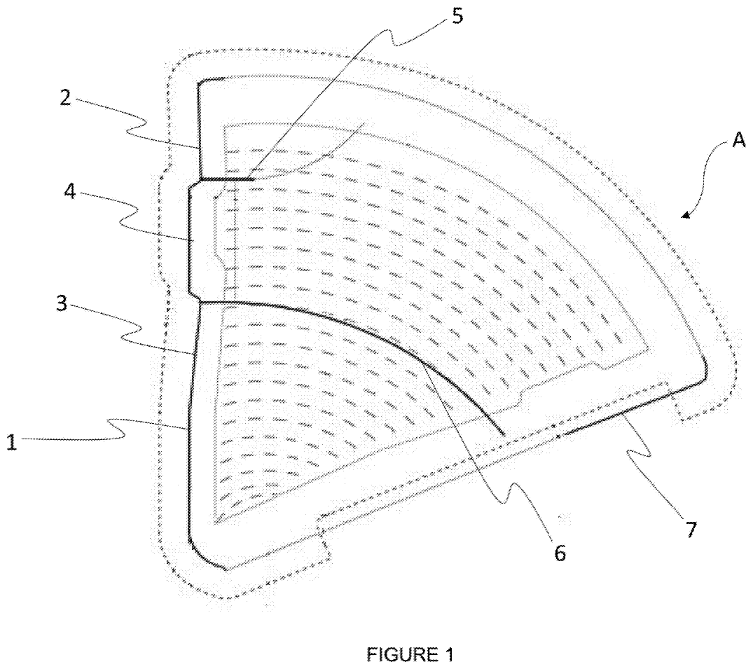

FIG. 1 shows the unfolding of the easy tear cornet package (A). Said cornet package (A) is generally cone-shaped.

The upper curve (2) and the lower curve (3) are inwardly formed on the outer edge line (1) forming the opening portion of the cornet package (A). The holding protrusion (4), the width of which is more outside the outer edge line (1) and the right and left edges of which are in the inward-angled form, are provided between the upper curve (2) and the lower curve (3). By this way, the holding protrusion (4) formed between the upper curve (2) and the lower curve (3) of the outer edge line (1) forming the opening portion of the cornet package (A) is enabled to be easily seen and easily gripped. Furthermore, said holding protrusion (4) is situated higher than the half-length of the length of the cornet package (A).

Upper tear line (5) which has concave form and “−” shape and which starts from the upper corner of the holding protrusion (4), which is on the outer edge line (1) and formed so as to be more outside said outer edge line (1), and extends toward the upper edge of the cornet package is formed.

Furthermore, lower tear line (5) which has concave form and shape and which starts from the lower corner of the holding protrusion (4), which is on the outer edge line (1) and formed so as to be more outside said outer edge line (1), and extends toward the inner edge line (7) of the cornet package (A) is formed.

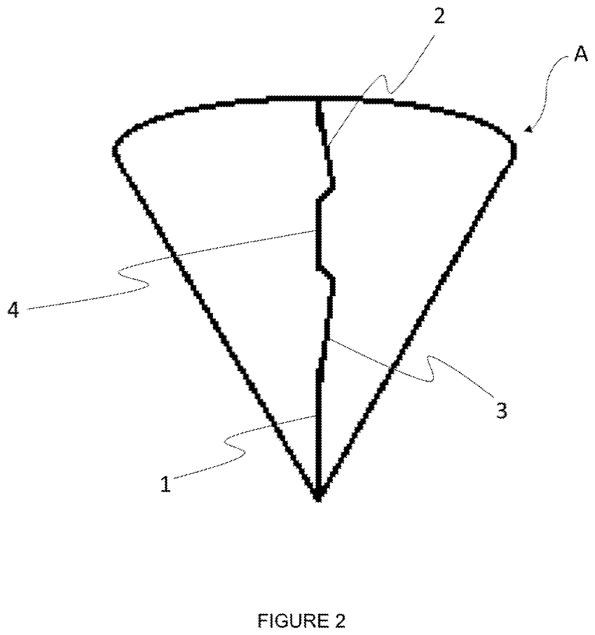

The cornet package (A) is wrapped around the cornet ice cream cone in such a way that its inner edge line (7) remains inside, and fixed by adhering the surface of the cornet package (A) through the inner surface of the outer edge line (1). The closed form of the cornet package (A) is shown in FIG. 2.

Cornet package (A) is easily separated from the cornet ice cream by easily holding and pulling the holding protrusion (4) and tearing correctly and in a wide area from the upper tear line (5) and the lower tear line (6) both having the concave form and “−” shape and starting from the upper and lower corners of said holding protrusion (4).

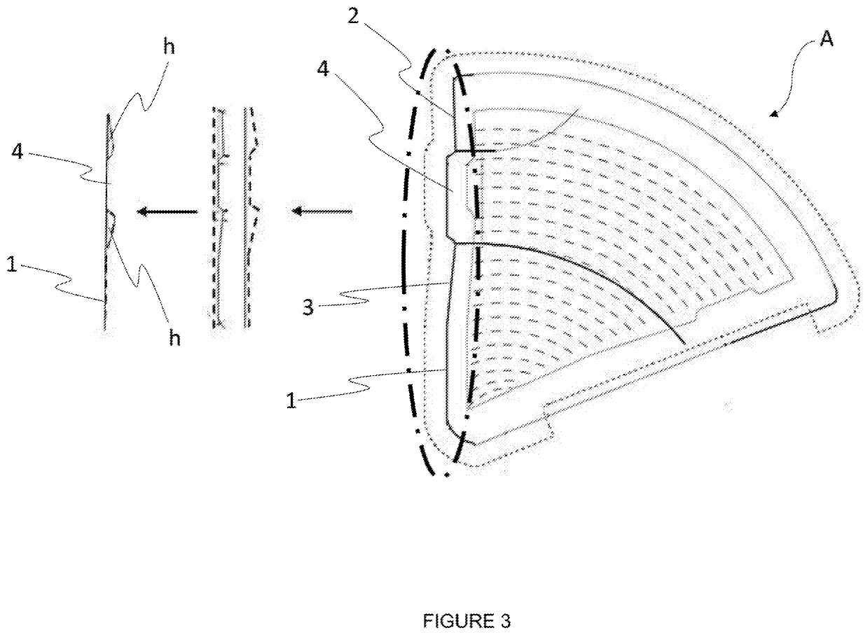

FIG. 3 is a detail view of the outer edge line (1) of the production waste of the cornet package (A). According to this, the waste raw material (h) forms the part coming out of the portion between the outer edge line (1), and said upper curve (2) and said lower curve (3) by the inwardly cutting of the outer edge line (1) in a vertical plane. Thus, the waste raw material (h) has been diminished and the cost of the cornet package (A) has been reduced.

1. A cone-shaped and easy-to-tear cornet package (A) used for packaging the cone-shaped cornet-type ice creams, characterized in that it comprises
upper curve (2) and lower curve (3) which are inwardly formed and which are on the outer edge line (1) forming the opening portion,
holding protrusion (4) which is between the upper curve (2) and the lower curve (3), the width of which is more outside the outer edge line (1) and the right and left edges of which are in the inward-angled form,
upper tear line (5) which has concave form and shape and which starts from the upper corner of the holding protrusion (4) and extends toward the upper edge of the cornet package,
lower tear line (6) which has concave form and “−” shape and which starts from the lower corner of said holding protrusion (4) and extends toward the inner edge line (7) of the cornet package (A).

2. Easy tear cornet package (A) according to claim 1, characterized in that said holding protrusion (4) is situated higher than the half-length of the length of the cornet package (A).

3. Easy tear cornet package (A) according to claim 1, characterized in that the waste raw material (h) forms the part coming out of the portion between the outer edge line (1), and said upper curve (2) and the lower curve (3) by the inwardly cutting of the outer edge line (1) in a vertical plane.
